(19) United States
(12) Patent Application Publication
(10) Pub. No.: US 2017/0374395 A1
(43) Pub. Date: Dec. 28, 2017

(54) VIDEO MANAGEMENT SYSTEMS (VMS)

(71) Applicant: The United States of America as represented by the Secretary of the Navy, Crane, IN (US)

(72) Inventors: Lucas Johnson, Bloomington, IN (US); Timothy Adams, Bloomington, IN (US); Jordan Brown, Bloomington, IN (US)

(21) Appl. No.: 15/195,987

(22) Filed: Jun. 28, 2016

(51) Int. Cl. H04N 21/2365; H04N 21/84; H04N 21/47; H04N 21/845; H04N 21/234

(52) U.S. Cl. CPC H04N 21/2365; H04N 21/8456; H04N 21/234; H04N 21/47; H04N 21/84

(57) ABSTRACT

Apparatus and methods are developed that facilitate the control and streaming of multiple video streams. The apparatus and methods may include a video management system (VMS) that includes a VMS server device, a VMS client device, and a VMS graphical user interface (GUI) device. The VMS server device may be configured to receive multiple video streams and store them in memory. The VMS GUI device may be configured to provide commands to the VMS client device relating to the video streams accessible by the VMS server device. The VMS GUI device may also query a VMS server device for available video streams or for metadata related to a particular video stream. The VMS client device may be configured to receive the commands from the VMS GUI device and transmit commands to the VMS server device based on the commands received from the VMS GUI device.

### STATEMENT REGARDING FEDERALLY SPONSORED RESEARCH OR DEVELOPMENT

The invention described herein was made in the performance of official duties by employees of the Department of the Navy and may be manufactured, used and licensed by or for the United States Government for any governmental purpose without payment of any royalties thereon. This invention (Navy Case 103,263) is assigned to the United States Government and is available for licensing for commercial purposes. Licensing and technical inquiries may be directed to the Technology Transfer Office, Naval Surface Warfare Center Corona Division.

### FIELD OF THE DISCLOSURE

The invention relates generally to apparatus and methods for the streaming of video and, more specifically, for the managing, controlling, and displaying of video streams.

### BACKGROUND

Current systems allow for the storing and playback of video streams. For example, in the home security area, today's systems allow users to view online a live video feed of one or more cameras directed towards one's property. Some systems also allow for the recording of the live video feeds, while the same or other systems allow for the ability to stream recorded video. Other systems, such as ground-based surveillance systems used by the defense sector, may provide multiple video streams from various system sensors, such as cameras. The video streams may include video data as well as metadata (i.e., data that describes the video stream). These systems, however, may present several challenges.

For example, while some systems allow for the ability to stream video, users of those systems may not have much control over the streaming process. For example, users may have difficulty moving to a specific video frame. As such, the systems may have limited playback capabilities. The systems may not allow for the ability to take a snapshot of a video frame, and may not include an ability to scroll through a video timeline of the video stream. The systems also require the importing of video data before one is able to view or see a snapshot of a video frame. Other problems include support of video playback in only certain formats, such as support for video in the MPEG-2 video format but not the H.264 video format. Archived video retrieval presents issues in these systems as well, as systems made video retrieval available by having users search through a directory. Prior art systems also presented the problem of not allowing the searching of video archives through metadata or event tags. Other problems included the inability of the prior art systems to allow archiving of video streams to be viewed on multiple clients. The prior art systems also experienced other disadvantages, such as inoperability with certain operating systems and had limited storage capability, among other disadvantages. Thus, there are opportunities to address these and other needs in the management of video streams.

### SUMMARY OF THE DISCLOSURE

Apparatus and methods have been developed that facilitate the control and streaming of multiple video streams (e.g., video feeds). The apparatus and methods provide for the exploitation of full motion video, including archive and sorting procedures, for rapid recovery, analysis, and sharing of the video. The apparatus and methods may also provide video handling features, including the ability to save image snapshots (such as, for example, in the Joint Photographic Experts Group (JPEG) and National Imagery Transmission Format (NITF) formats), to embed critical metadata into the video, to export video to removable media, to render and view exported video, and to conduct quick content-based search and retrieval. In addition, the apparatus and methods allow for the capturing and displaying of both live and archived video streams.

As an example, the apparatus and methods may include a video management system (VMS) that includes a VMS server device, a VMS client device, and a VMS graphical user interface (GUI) device. The VMS server device may be configured (e.g., adapted) to receive multiple video streams and store the multiple video streams in memory. The video streams may include live or archived video streams, and each video may include video data and metadata (as is known in the art, metadata may include information that describes the video stream, including, for example, Motion Imagery Standards Board (MISB) supported standards, such as MISB standard 0601). The VMS server device may read metadata associated with the video streams and may store the metadata in a database. The VMS server device may be configured to receive commands related to one or more of the video streams, and in response may provide at least one video frame of the video streams. The VMS server device may also, or instead, provide metadata associated with one or more of the video streams in response to the received commands.

In one example, the VMS server device embeds metadata into video and creates files that may be exported, such as the video itself and images based on the video. The VMS GUI device provides a user interface to view exported videos. As such, a user may select an exported video to view. For example, when a user wishes to view an exported video, the VMS client device may render the exported video in the VMS GUI device. The VMS GUI device may also include controls to edit the videos and associated images, and controls to have the exported videos and images copied to removable media.

The video management system may also include a VMS GUI device adapted to provide for display at least one video frame of a video stream. The VMS GUI device may be configured to provide one or more query commands relating to the video streams accessible (e.g., maintained) by the VMS server device as described further below. The VMS GUI device may also be configured to provide one or more control commands relating to video streams accessible by the VMS server device, also described further below. The VMS GUI device may also display a graphical user interface (GUI) that allows for a user to query the VMS server device, or control one or more of the video streams accessible by the VMS server device. For example, as discussed further below, the VMS GUI device may display a GUI that, in response to manipulations by a user (e.g., selection of a button), may cause query commands to be transmitted. The query commands may query a VMS server device for available video streams or for metadata related to a particular video stream accessible by the VMS server device. As another example, the VMS GUI device may transmit control commands in response to user manipulations so as to cause the playback of a video stream accessible by a VMS server device.

The video management system may also include a VMS client device that is in communication with the VMS server device and the VMS GUI. The VMS client device may be configured to receive the query commands and the control commands from the VMS GUI device, and transmit a command (e.g., message) to the VMS server device based on the commands received from the VMS GUI device. As such, while the VMS client device may follow a specific protocol in delivering commands to the VMS server device, the VMS GUI device does not need to be aware of that specific protocol as it may not communicate directly with the VMS server device and instead may issue its commands to the VMS client device. The VMS client device may, in response to a command transmitted to a VMS server device, receive from the VMS server device a video frame of a video stream accessible by the VMS server device (e.g., a video frame of a live or archived video stream). The VMS client device may in addition, or instead, receive metadata associated with a video stream accessible by the VMS server device in response to a command transmitted to the VMS server device.

In one embodiment, the VMS GUI device, based on a selection of one of a listing of available video streams, may provide for display either a live video stream or an archived video stream. For example, the VMS GUI device may display a GUI that allows a user to select a video stream that is available on a VMS server device. The available video stream may be a live stream, or an archived video stream. Upon a user selecting an available video steam, the VMS GUI device may provide a control command to the VMS client device based on the selected video stream. In response, the VMS client device may provide a command to the VMS server device to provide the selected video stream. For example, the VMS server device may provide a video frame of the video stream, which may be made available to the VMS GUI device via the VMS client device. In another embodiment, the VMS GUI device is further adapted to provide for display metadata associated with the selected video stream.

In one example, the VMS GUI device is adapted to provide one or more control commands to the VMS client device to control playback of the at least one video stream from the VMS server device. For example, through the use of the control commands, the VMS GUI device may play, pause, or stop the video stream. In one example, the VMS GUI device is adapted to provide one or more control commands to the VMS client device to delete at least one video stream from a VMS server device. In another example, the VMS GUI device is adapted to provide one or more control commands to the VMS client device to have additional video streams added to the VMS server device. For example, the VMS GUI device may provide a command to the VMS client device to have a live video stream added to the VMS server device, such that the live video stream is archived by the VMS server device. The video stream may then become an available video stream, such as one that the VMS client device may request for viewing.

In another example, the VMS GUI device is adapted to provide one or more control commands to the VMS client device to control the application of at least one video filter to a video stream from the VMS server device. As known in the art, various video filters, such as a de-interlace filter, may be applied to a video stream. In this manner, the VMS GUI device may control the application of one or more video filters to a video stream accessible by the VMS server device. In one embodiment, the VMS GUI device is adapted to provide one or more control commands to the VMS client device to command the VMS client device to connect to a second VMS server device to allow the VMS client device to access archived or live video streams on the second VMS server device.

In one embodiment, the VMS GUI device is adapted to provide one or more query commands to the VMS client device to query the VMS server device, based on indicated metadata criteria, for a list of video streams accessible by the VMS server device that satisfy indicated metadata criteria. For example, a user may want to identify video streams accessible by a VMS server device that satisfy certain metadata criteria. As such, the user may identify the metadata criteria that a video stream must satisfy via the GUI displayed by the VMS GUI device. Once identified, the VMS GUI device may provide a query command to the VMS client device with an indication of the identified metadata criteria. The VMS client device may then provide a query command to the VMS server device based on the received metadata criteria to retrieve an indication (e.g., a list) of available video streams accessible by the VMS server device that meet the identified metadata criteria. In response, the VMS server device may provide an indication (e.g., a response message) of available video streams that satisfy the identified metadata criteria.

In another embodiment, the VMS GUI device is adapted to provide one or more query commands to the VMS client device to query the VMS server device for availability of one or more video streams (e.g., video streams accessible by the VMS server device, video streams recorded by the VMS server device). For example, a user may want to identify video streams that are available via a particular VMS server device. As such, the user may identify a particular VMS server device via the GUI displayed by the VMS GUI device. Once identified, the VMS GUI device may provide a query command to the VMS client device with an indication of the VMS server device. The VMS client device may then provide a query command to the identified VMS server device based on the received VMS server device indication. In response, the VMS server device may provide an indication (e.g., a list) of available video streams.

In yet another embodiment, the VMS GUI device is adapted to provide one or more query commands to the VMS client device to query the VMS server device for availability of one or more video streams during a particular timeline. For example, a user may want to identify video streams that are available during a particular time window (e.g., a time interval including a start time and an end time). As such, the user may identify the particular timeline via the GUI displayed by the VMS GUI device. Once identified, the VMS GUI device may provide a query command to the VMS client device with an indication of the particular timeline. The VMS client device may then provide a query command to the VMS server device based on the requested timeline to retrieve an indication (e.g., a list) of available video streams accessible by the VMS server device that are available during the requested timeline. In response, the VMS server device may provide an indication of video streams that are available during the requested timeline. In one embodiment, the VMS GUI device identifies a particular video stream, in addition to a particular timeline, in a query command to the VMS client device. The VMS client device then provides a query command to the VMS server device to determine if the particular video stream is available during the identified timeline. In response, the VMS server device may respond with an indication of whether the identified video stream is available during the requested timeline.

In another embodiment, the VMS GUI device is adapted to provide one or more query commands to the VMS client device to command the VMS server device to save an image of a video frame of at least one video stream. For example, a user may want to save one or more video frames of a video stream that is available via a particular VMS server device. As such, the user may identify a video frame of a video stream to be saved by a VMS server device via the GUI displayed by the VMS GUI device. For example, the GUI may be displaying a video stream from a particular VMS server device. A user may then select a “SAVE” icon displayed on the GUI. In response, the VMS GUI device may provide a query command to the VMS client device indicating that the current video frame of the video stream is to be saved. The VMS client device may then provide a query command to the identified VMS server device based on the received query command. In response, the VMS server device may save an image of the video frame in memory. As such, the saved image of the video frame may be available for viewing at a later time. In another embodiment, the VMS GUI device is adapted to provide one or more query commands to the VMS client device to command the VMS server device to save multiple video frames of at least one video stream, such as a video clip of a video frame. In this example, the user may identify a start point and an end point (e.g., start time and end time) of a video stream to be saved by a VMS server device via the GUI displayed by the VMS GUI device. A user may then select a “SAVE” icon displayed on the GUI. In response, the VMS GUI device may provide a query command to the VMS client device indicating that the video frames of the video stream falling within the start point and end point are to be saved.

In some embodiments, the VMS client device may be adapted to provide a response to the VMS GUI device based on receiving at least one or more VMS GUI query commands or one or more VMS GUI control commands. For example, in one example, the VMS client device may provide an acknowledgement (e.g., ACK/NAK) response to indicate that a request was acknowledged or not acknowledged. For example, an ACK/NAK message may be sent in response to a request only if the request does not require data. In other words, if a request doesn't require a more detailed response, then this message will be sent. As another example, an ACK/NAK message may be sent whenever an error occurs with any request.

In other examples, the VMS client device may be adapted to provide a message to the VMS GUI device regardless of receiving at least one or more VMS GUI query commands or one or more VMS GUI control commands from the VMS GUI device. For example, the VMS client device may send a link status message to the VMS GUI device on a periodic message. Such message may indicate to the VMS GUI device that the VMS client device is available (e.g., up and running). As another example, the VMS client device may send a message indicating progress status of various operations. Such progress status may include, for example, the status of video importing and video clip saving.

Additional features and advantages of the present invention will become apparent to those skilled in the art upon consideration of the following detailed description of the illustrative embodiment exemplifying the best mode of carrying out the invention as presently perceived.

### BRIEF DESCRIPTION OF THE DRAWINGS

The detailed description of the drawings particularly refers to the accompanying figures in which:

FIG. 1 is a functional block diagram of a video management system that includes a plurality of VMS server devices, a VMS client device, and a VMS graphical user interface (GUI) device according to one example of the present disclosure;

FIG. 2 is an example listing of various messages that may be exchanged between a VMS client device and a VMS GUI device in accordance with one example of the present disclosure;

FIG. 3 is another functional block diagram that includes a VMS server device, a VMS client device, and a VMS GUI device according to one example of the present disclosure;

FIG. 4 is a flowchart of an example method for a video management system in accordance with one example of the present disclosure;

FIG. 5 is another example a flowchart of an example method for a video management system in accordance with one example of the present disclosure;

FIG. 6 is an example system that includes a VMS server device, a VMS client device, and a VMS GUI device, and VMS server device logic code, VMS client logic code, and VMS GUI logic code residing in memory, in accordance with one example of the present disclosure;

FIG. 7 is an example window of a GUI that is displayed and that a user may interact with to initiate one or more functions of the video management system described herein in accordance with one example of the present disclosure;

FIG. 8 is another example window of a GUI that is displayed and that a user may interact with to initiate one or more functions of the video management system described herein in accordance with one example of the present disclosure;

FIG. 9 is another example window of a GUI that is displayed and that a user may interact with to initiate one or more functions of the video management system described herein in accordance with one example of the present disclosure;

FIG. 10 is another example window of a GUI that is displayed and that a user may interact with to initiate one or more functions of the video management system described herein in accordance with one example of the present disclosure; and

FIG. 11 is another example window of a GUI that is displayed and that a user may interact with to initiate one or more functions of the video management system described herein in accordance with one example of the present disclosure.

### DETAILED DESCRIPTION OF THE DRAWINGS

The embodiments of the invention described herein are not intended to be exhaustive or to limit the invention to precise forms disclosed. Rather, the embodiments selected for description have been chosen to enable one skilled in the art to practice the invention.

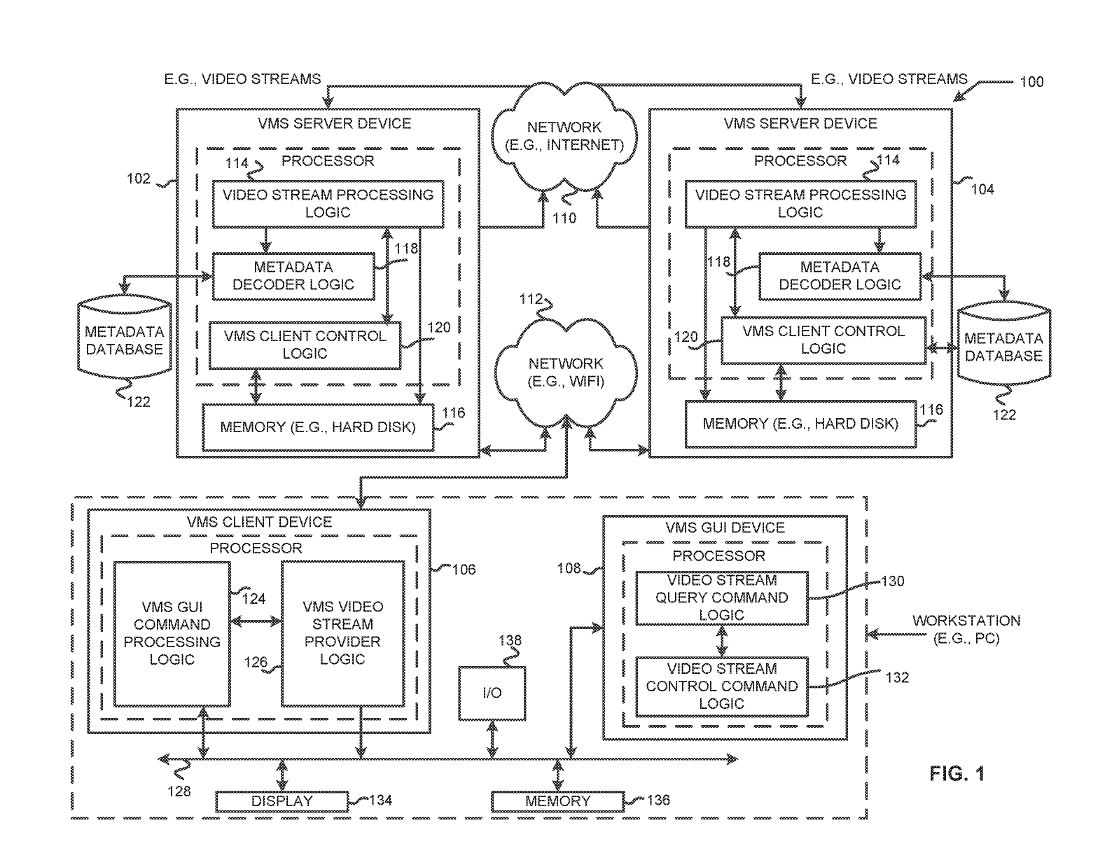

FIG. 1 shows an example functional block diagram of a video management system 100 that includes VMS server device 102, VMS server device 104, VMS client device 106, and VMS GUI device 108. Although two VMS server devices 102, 104, one VMS client device 106, and one VMS GUI device 108 are shown, video management system 100 may include any number of VMS server devices 102, 104, VMS client devices 106, and VMS GUI devices 108. Each VMS server device 102, 104, as well as VMS client device 106 and VMS GUI device 108, in some examples, may be a personal computer, laptop, tablet, workstation, or any other suitable device. In some embodiments, the functions of VMS client device 106 and VMS GUI device 108 may be performed by the same device. In other embodiments, the functions of VMS server device 102, 104, VMS client device 106, and VMS GUI device 108 may be performed by the same device.

In the example of FIG. 1, each VMS server device 102, 104 is operably coupled to network 110. Network 110 may be any suitable network, such as a cellular wireless communication network, a WiFi network, or any other suitable network, and may provide internet access. VMS server devices 102, 104 may also be operably coupled to network 112, which may also be any suitable network. While networks 110, 112 are shown as two networks, they may instead be the same network. VMS client device 106 and VMS GUI device 108 are also operably coupled to network 112.

Each VMS server device 102, 104 includes video stream processing logic 114. Video stream processing logic 114 is adapted to receive multiple video streams, such as from network 110, and may store the video streams in memory 116. For example, a VMS server device 102, 104 may access video streams as provided by other equipment (e.g., cameras, servers) via network 110. As mentioned above, each video stream may include video data and metadata. Video stream processing logic 114 may provide one or more video streams to metadata decoder logic 118, where metadata decoder logic 118 is operable to parse out metadata from a received video stream (e.g., read the metadata associated with video stream) and store the metadata into metadata database 122. Metadata database 122 may be any suitable storage device, such as a server, a workstation, memory card, or any other suitable memory device.

VMS server devices 102, 104 also include VMS client control logic 120. VMS client control logic 120 is operable (e.g., adapted) to receive a VMS client query command from VMS client device 106. As will be discussed further below, the VMS client query command may relate to at least one video stream, such as one accessible by video stream processing logic 114, or one stored in memory 116. Based on a received VMS client query command, VMS client control logic 120 may provide a video stream (or parts thereof), or information relating to the video stream, to VMS client device 106. For example, VMS client control logic 120 may provide at least one video frame of a video stream to VMS client device 106 by, for example, accessing video streams stored in memory 116. As another example, VMS client control logic 120 may provide some or all metadata associated with a video stream to VMS client device 106. For example, VMS client control logic 120 may access metadata associated with a video stream identified in a received VMS client query command that is stored in metadata database 122, and provide it to VMS client device 106 via, for example, a message. As indicated, the functions of video stream processing logic 114, metadata decoder logic 118, and VMS client control logic 120 may be performed by one or more processors such as a central processing unit (CPU), digital signal processor (DSP), microprocessor, or any other suitable processors.

As indicated in the figure, VMS client device 106 is operably coupled to network 112. For example, via network 112, VMS client device may communicate with VMS server device 102, 104. VMS client device 106 includes VMS GUI command processing logic 124 and VMS video stream provider logic 126. In one example, the functions of VMS GUI command processing logic 124 and VMS video stream provider logic 126 may be performed by one or more processors.

VMS GUI command processing logic 124 is operable to receive VMS GUI query commands and VMS GUI control commands from VMS GUI device 108 over communication bus 128. VMS GUI query commands and VMS GUI control commands are described further below. Based on received VMS GUI query commands and VMS GUI control commands, VMS GUI command processing logic 124 is operable to determine at least one VMS client query command to transmit to the VMS server device. VMS GUI command processing logic 124 is also operable to provide (e.g., transmit) the VMS client query command to the VMS server device. For example, a VMS GUI query command may indicate a request for video streams available to VMS server device 102, 104. In response, VMS client device 106 may determine to transmit a VMS client query command to VMS server device 102, 104 where the VMS client query command requests a list of available video streams. VMS client device 106 may transmit the VMS client query command to VMS server device 102, 104 over network 112. VMS GUI command processing logic 124 may also be operable to receive a VMS client response from VMS server device 102, as discussed further below.

VMS video stream provider logic 126 is adapted to receive from the VMS server device video streams from VMS server device 102, 104. For example, VMS video stream provider logic 126 may receive from VMS server device 102, 104 a video frame of a video stream, or metadata associated with a video stream. The video stream, video frame, or metadata may be received based on a VMS client query command transmitted to VMS server device 102, 104. VMS video stream provider logic 126 is also adapted to provide the received video streams, video frames, and metadata to VMS GUI device 108 over communication bus 128. In one example, VMS video stream provider logic 126 is operable to provide a video stream for display to display 134 over communication bus 128.

VMS GUI device 108 includes video stream query command logic 130 and video stream control command logic 132. In one example, the functions of video stream query command logic 130 and video stream control command logic 132 may be performed by one or more processors. Video stream query command logic 130 is adapted to provide one or more VMS GUI query commands that may relate to a video stream stored or accessible by VMS server device 102, 104. For example, a VMS GUI query command may indicate that the VMS client device 106 is to query the VMS server device 102, 104 for availability of one or more video streams. Video stream query command logic 130 is also adapted to provide one or more VMS GUI control commands that may relate to a video stream stored or accessible by VMS server device 102, 104. For example, a VMS GUI control command may indicate that a video filter should be applied to a particular video stream, or that a particular video stream should be played.

VMS GUI device 108 is operable to provide for display a received video stream (e.g., a video frame of a video stream), and metadata associated with a video stream. For example, VMS GUI device 108 may receive a requested video stream from VMS client device 106, and provide it for display to display 134 over communication bus 128. VMS GUI device 108 may also include VMS GUI display logic (not shown) that is adapted to provide for display a GUI that allows for control of a displayed video frame of a video stream. The GUI may be displayed, for example, on display 134. A user may interact with the GUI via I/O device 138. I/O device 138 may be any suitable input/output device such as a keyboard, a stylus, a touchpad, or any other suitable I/O device. VMS GUI device 108 may also be operable to store information related to a video stream, such as metadata, in memory device 136 over communication bus 128.

Some or all of the functionality described above may be implemented in hardware or a combination of hardware and hardware executing suitable instructions. Suitable hardware may include one or more processors (e.g., central processing units (CPUs)), ASICs, state machines, FPGAs, or other suitable hardware. Some or all of the functionality described above may also be implemented in any other suitable manner such as, but not limited to, a software implementation including, for example, a driver implementation, a firmware implementation, a hardware implementation, or any suitable combination of the example implementations described above. In some examples, the executable suitable instructions may be stored on a computer readable storage medium, where the executable instructions are executable by one or more processors to cause the one or more processors to perform the actions described herein. Computer readable storage medium may include, for example, flash memory, any non-transitory computer readable medium such as but not limited to RAM or ROM, a cloud storage mechanism, or any other suitable storage mechanism.

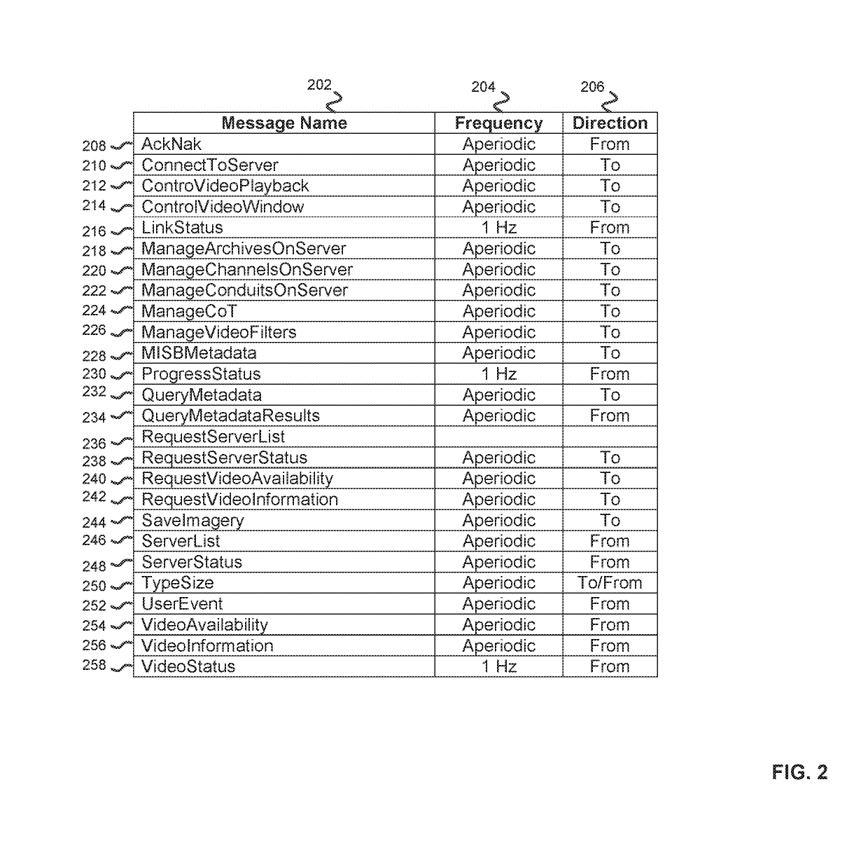

FIG. 2 is an example listing of various messages that may be exchanged between an example VMS client device, such as VMS client device 106, and a VMS GUI device, such as VMS GUI device 108. The first column 202 includes a message name for each message. The second column includes an example of how frequent a particular message may be sent. The third column includes the direction of the message (i.e., from VMS client device or to VMS client device). For example, a direction of “From” indicates that the message is from the VMS client device (e.g., from the VMS client device to the VMS GUI device), and a direction of “To” indicates that the message is to the VMS client device (e.g., from the VMS GUI device to the VMS client device).

Message AckNak 208 may be sent by a VMS client device as a general reply to indicate that a request was acknowledged or not acknowledged. In general, this message is sent in response to a request only if the response does not require data. In other words, if the response doesn't require a more detailed response, then this message will be sent. Also, this message will be sent whenever an error occurs with any request.

Message ConnectToServer 210 may be sent by a VMS GUI device to connect to a new VMS server device. This will allow the client to search archives and view live feeds connected to the new VMS server device. Message ControVideoPlayback 212 may be sent by a VMS GUI device to control the playback of a video feed (e.g., stream). The VMS Client must already be connected to the feed and a window to show the requested video feed must be created prior to sending this message. Message ControlVideoWindow 214 may be sent by a VMS GUI device to create a new video window (e.g., such as one associated with a GUI displayed by the VMS GUI device), move an existing one, or delete an existing one. This must be called before a video can be played.

Message LinkStatus 216 may be sent by a VMS client device on a periodic basis from the VMS client device to the VMS GUI device to inform the VMS GUI device that the VMS client device is awake (e.g., up and running). Message ManageArchivesOnServer 218 may be sent by a VMS GUI device to manage archives and recordings of live feeds on a connected VMS server device. Message ManageChannelsOnServer 220 may be sent by a VMS GUI device to manage channels, which may provide video archives that are broadcast from a VMS server device, on a connected VMS server device. ManageConduitsOnServer 222 may be sent by a VMS GUI device to add additional conduits (live) feeds to a VMS server device, which ultimately get archived and show up as available feeds on a VMS client. A conduit may be a connection to a video encoder.

Message ManageCoT 224 may be sent by a VMS GUI device to manage which feeds use Cursor On Target (CoT), an XML-based protocol used for the transfer of tactical information (e.g., such as description of an object, time of an event, or a position of an event). Key-Length-Value (KLV) metadata may be encoded into a CoT Event according to the conversion defined by MISB Engineering Guideline 0805 titled “Cursor on Target Conversions for Key-Length-Value Metadata,” for example. This method will create either a Platform Position, or Sensor Point of Interest (SPI) CoT Event, or both, for incoming metadata.

Message ManageVideoFilters 226 may be sent by a VMS GUI device to control video filters that may be applied to a video stream by a VMS server device. For example, this message may indicate that a de-interlacing filter should or should not be applied to a video stream. Message MISBMetadata 228 may be sent from a VMS client device to a VMS GUI device to describe metadata associated with a metadata packet that is received. For example, the message may be sent as often as data changes within a metadata elementary stream of an incoming video.

Message ProgressStatus 230 may be sent by a VMS client device to announce status of various operations, including video importing and video clip saving. This message is generic so that any operation requiring the reporting of progress to the VMS GUI device can be handled. For example, when importing an external video file into a VMS server device, an identification (ID) is generated at the VMS GUI device and is passed in a request to the VMS client device. When the VMS client device publishes progress back to the VMS GUI device, this ID is included in each message for that particular action.

Message Query Metadata 232 may be sent by a VMS GUI device to query a server for video feeds that contain the given search criteria. Message QueryMetadataResults 234 may be sent by a VMS client device to return results of a metadata query from a VMS client device. Message RequestServerList 236 may be sent by a VMS GUI device to retrieve status of connected VMS server devices, including disk information and connected VMS client devices. Message ServerList 246 may be sent by a VMS client device to request a list of VMS server devices that a particular VMS client device has access to. For example, message ServerList 246 may be sent in response to a received RequestServerList 236 message. In one example, if multicast discovery is turned on at a VMS server device, then this list will include other available servers. However, if multicast discovery is turned off at the VMS server device, then only VMS server devices that the VMS client device is currently connected to will be included.

Message RequestServerStatus 238 may be sent by a VMS GUI device to retrieve status of connected servers, including disk information and connected VMS client devices. Message RequestVideoAvailability 240 may be sent by a VMS GUI device to query a VMS server device for video availability, such as intervals representing when video has been recorded to a disk. For example, the VMS server device may record a video stream when a live feed is added. However, if a video encoder is powered off, or no video is present at the video encoder (e.g. a camera is turned off), then the VMS server device detects this and may catalog the events. An indication of video availability may be displayed to an operator of a VMS GUI device on a timeline associated with its corresponding video feed. Message VideoAvailability 254 may be sent by a VMS server device indicating video availability, such as the intervals described above. The VideoAvailability 254 message may be sent, for example, in response to a received RequestVideoAvailability 240 message.

Message RequestVideoInformation 242 may be sent by a VMS GUI device to query a VMS server device for available video feeds, such as live video feeds and archived video feeds. Message VideoInformation 256 may be sent by a VMS client device indicating available video feeds. The VideoInformation 256 message may be sent, for example, in response to a received RequestVideoInformation 242 message.

Message SaveImagery 244 may be sent by a VMS GUI device to have a still image or a video clip saved by the VMS server device. For example, the message may specify start and end times of a video stream to be saved. The VMS server device may save the image or video clip to a local memory, or may store it to network accessible memory. Message ServerStatus 248 may be sent by a VMS GUI device to receive status back for a connected VMS server device. In addition, a VMS server device may send this message to indicate that its hard drive is full and video data needs to be pruned. In one example, when data needs to be pruned, this message is published to all VMS client devices and an archives list is created consisting of video archives that will be impacted (e.g., deleted) by the pruning process. This message is forwarded to the VMS GUI so that an operator has an indication of which archives are impacted.

Message TypeSize 250, which may include a constant and known message size, may be sent by a VMS GUI device or a VMS client device ahead of (e.g., as a header to) other messages to allow its recipient, such as the VMS client device, to determine which message is being sent next. This is useful so that the recipient is aware of the type and length of the following message. Message UserEvent 252 may be sent by a VMS client device to a VMS GUI device when an action, such as a user action (e.g., mouse click), occurs. In this manner, the VMS GUI device may be made aware of various actions that take place at the VMS client device. Message VideoStatus 258 may be sent by a VMS client device to a VMS GUI device at a periodic rate for a video stream displayed by a VMS GUI device. As such, information such as timeline status, video speed, and direction may be indicated on a displayed GUI.

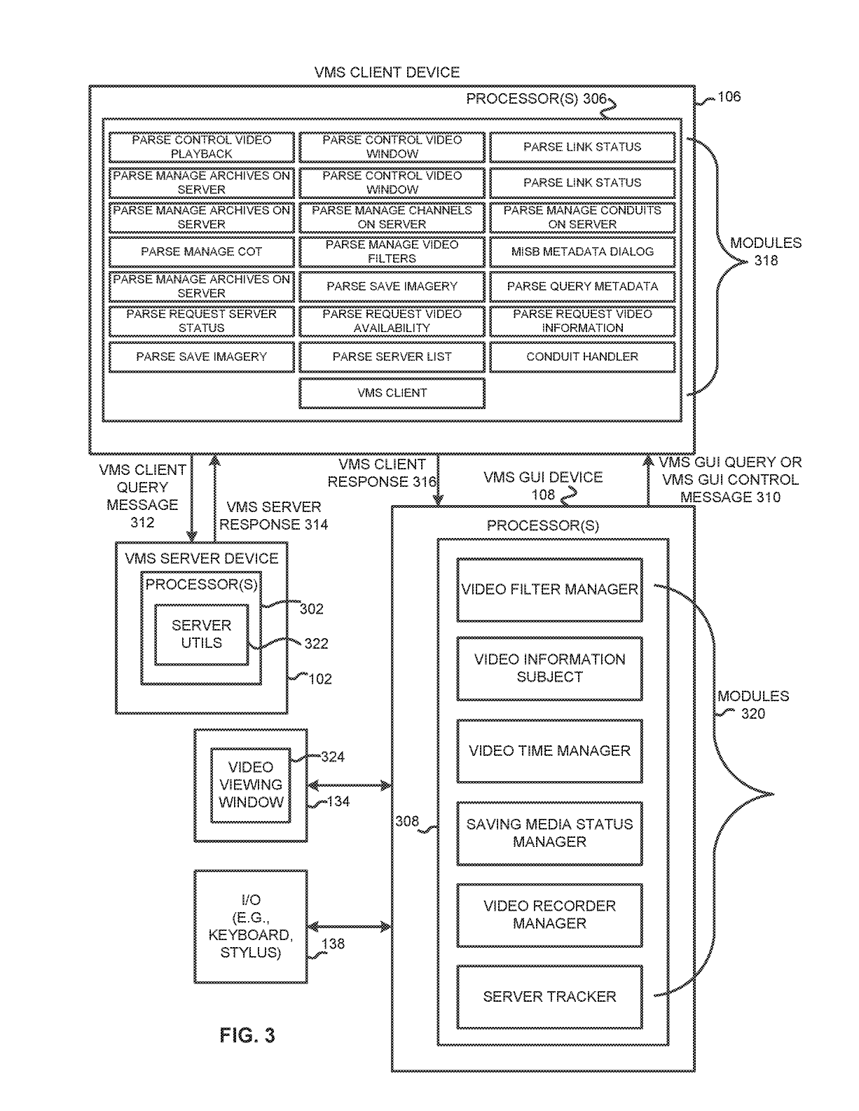

FIG. 3 is another functional block diagram that includes the VMS server device 102, the VMS client device 106, and the VMS GUI device 108 of FIG. 1. In this example, VMS server device 102 includes processor 302, which, when executing suitable instructions, may perform the functions of video stream processing logic 114, metadata decoder logic 118, and VMS client control logic 120. Similarly, in this example VMS client device 106 includes processor 306, and VMS GUI device 108 includes processor 308. Processors 306, 308, when executing suitable instructions, may perform the functions of VMS GUI command processing logic 124 and VMS video stream provider logic 126, and video stream query command logic 130 and video stream control command logic 132, respectively. Similarly, VMS server device 102 includes processor 302. Processor 302, when executing suitable instructions, may perform the functions of one or more of video stream processing logic 114, metadata decoder logic 118, and VMS client control logic 120.

For example, as indicated in the figure, processor 308 may include one or more VMS GUI device modules 320 that may be executed to implement one or more of the messages described above with respect to FIG. 2. In one example, the VMS GUI device modules 320 are implemented as shown in the code listing attached as appendix 1. Appendix 1 is incorporated by reference herein. Similarly, processor 302 may execute one or more VMS server device modules, such as the “Server Utils” module 322, to implement one or more of the messages described above with respect to FIG. 2. In one example, module “Server Utils” 322 is implemented as shown in the code listing attached as appendix 2, which is incorporated by reference herein. Processor 306 may include one or more VMS client device modules 318 that may be executed to implement one or more of the messages described above with respect to FIG. 2. In one example, the VMS client device modules 318 are implemented as shown in the code listing attached as appendix 3, which is incorporated by reference herein.

In one example, a user may interact with a video viewport window of a graphical user interface (GUI) 324 by using I/O device 138 to control video feeds, including the streaming of multiple video streams, among other functions.

As indicated in the figure, VMS GUI device 108 may transmit to VMS client device 106 a VMS GUI query or control message 310. In response, VMS client device 106 may provide to VMS server device 102 a VMS client query message 312. Based on the received VMS client query message 312, VMS server device 102 may provide a VMS server device response 314 to VMS client 108. Based on a received VMS server device response 314, VMS client device 106 may provide a VMS client response 316 to VMS GUI device 108. The VMS client response 316 may include, for example, an ACK/NAK message, or a periodic message, such as a link status message.

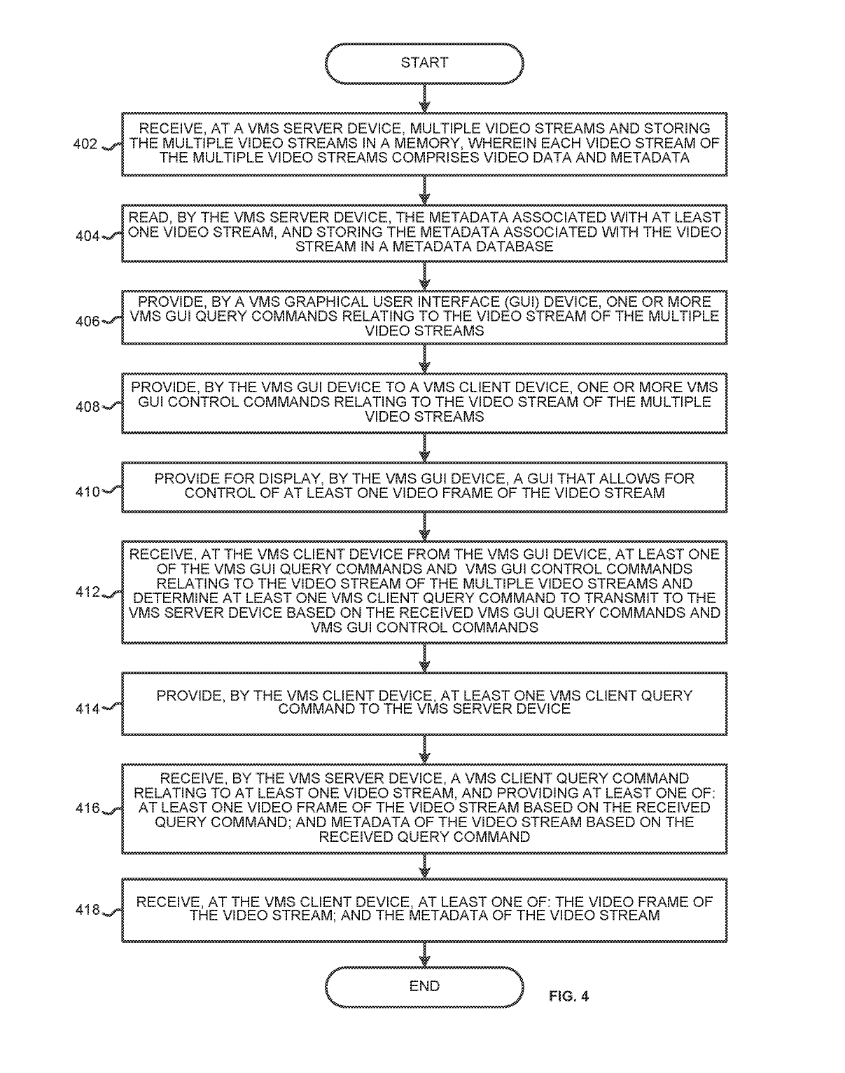

FIG. 4 illustrates an exemplary method 400 that may be realized, for example, by video management system 100. In various embodiments of the present disclosure, the steps or processes involved in method 400, and any other methods described herein, should not be limited to the sequence described in the present disclosure. One of ordinary skill in the art could readily understand the plurality of different options for organizing or executing the steps of the methods described herein in order to achieve substantially the same results or outcomes disclosed herein. Accordingly, the present disclosure contemplates that one of ordinary skill in the art may implement or execute one or more steps of the methods described herein in a plurality of different ways. Thus, the present disclosure should not be limited to the particular order disclosed in the methods described herein.

The method begins at step 402 where a VMS server device receives multiple video streams and stores the multiple video streams in a memory, where each video stream includes video data and metadata. The method proceeds to step 404 where the VMS server device reads the metadata associated with one or more video streams and stores the metadata in a metadata database. The method proceeds to step 406, where a VMS GUI device provides one or more VMS GUI query commands to a VMS client device relating to at least one of the video streams. At step 408 the VMS GUI device provides one or more VMS control commands to the VMS client device relating to at least one video stream. At step 410, the VMS GUI device provides for display a GUI that allows for control of at least one video frame of at least one video stream. At step 412 the VMS client device receives from the VMS GUI device at least one of the VMS GUI query commands and the VMS control commands relating to the video stream. The VMS client device then determines at least one VMS client query command to transmit to the VMS server device based on the received VMS GUI query commands and VMS GUI control commands. At step 414 the VMS client device provides the determined VMS client query commands to the VMS server device. At step 416, the VMS server device receives the one or more VMS client query commands relating to the video stream and provides, based on the received VMS client query commands, at least one of a video frame of the video stream and metadata of the video stream. At step 418 the VMS client device receives at least one of the video frame of the video stream and the metadata of the video stream.

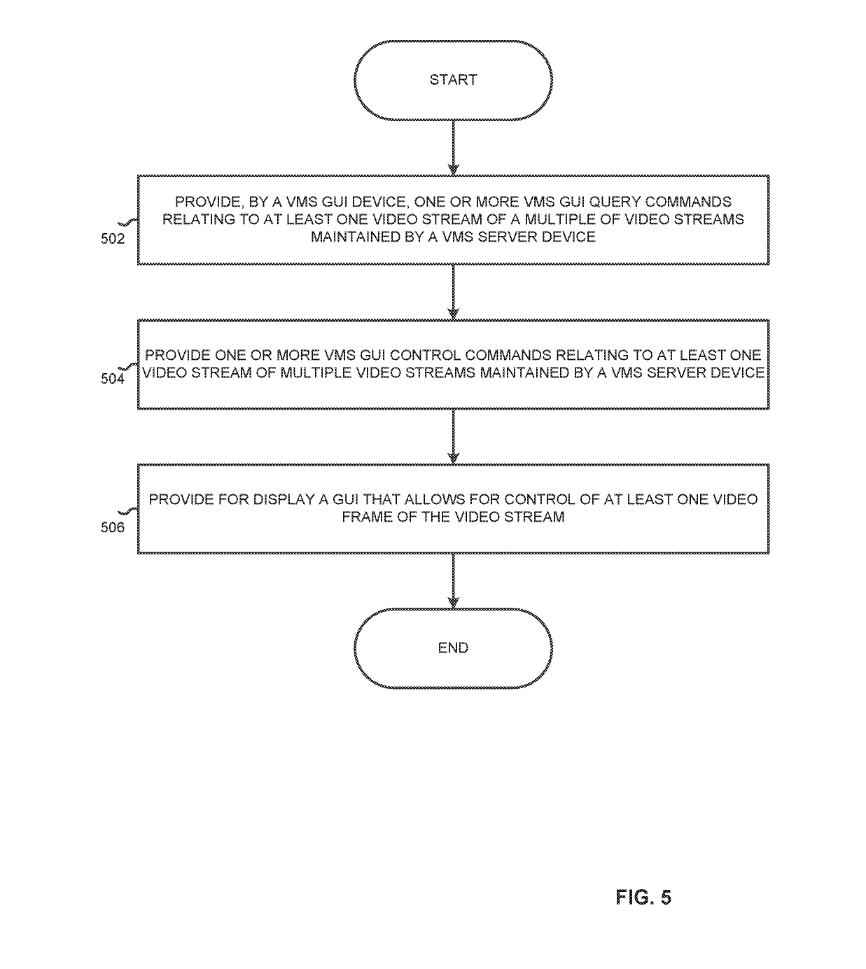

FIG. 5 is an example method that may be realized, for example, by VMS GUI device 108. The method begins at step 502, where a VMS GUI device provides one or more VMS GUI query commands relating to at least one video stream of a multiple video streams maintained by the VMS server device. At step 504, the VMS GUI device provides one or more VMS GUI control commands relating to at least one video stream of a multiple video streams maintained by the VMS server device. At step 506 the VMS GUI device provides for display a GUI that allows for control of at least one video frame of at least one video stream of the multiple video streams.

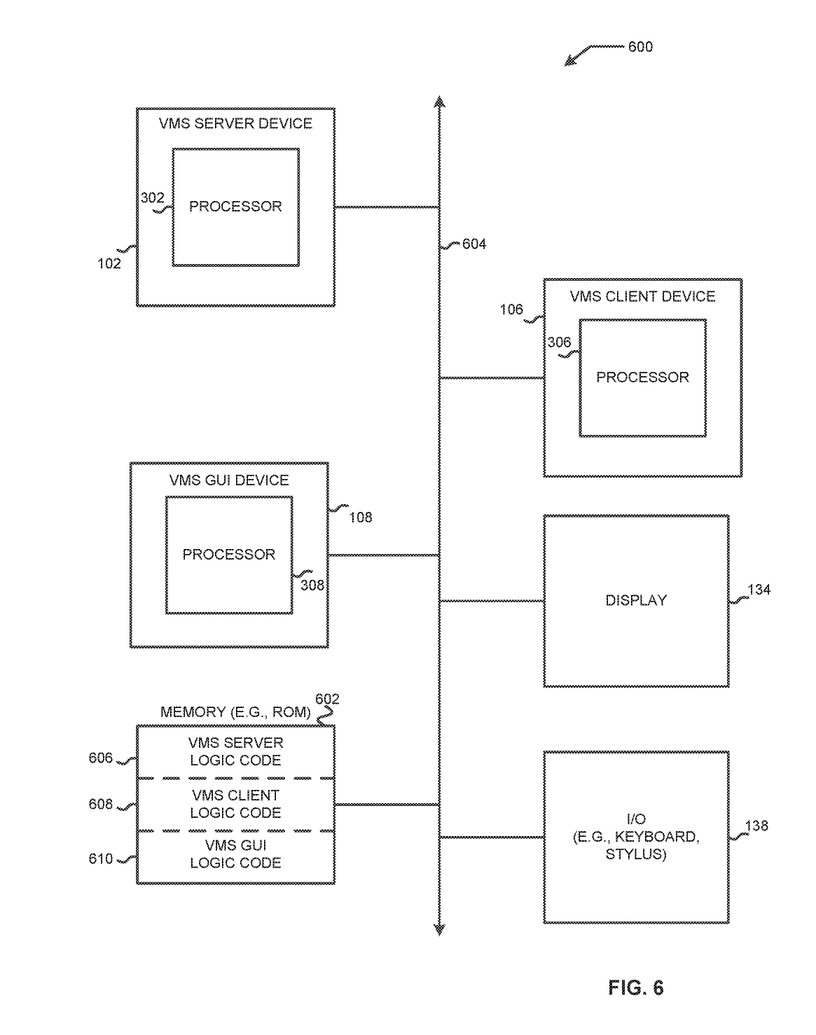

FIG. 6 is a functional block diagram illustrating an example video management system 600 employing a VMS server device 102 with processor 202, a VMS client device 106 with processor 206, and a VMS GUI device 108 with processor 208. Video management system 600 also includes a display 134, Input/Output device 138, and memory device 602. Each of these devices is operatively coupled to expansion bus 604.

In some examples, executable suitable instructions may be stored on a computer readable storage medium, where the executable instructions are executable by one or more processors to cause the one or more processors to perform the actions described herein. Referring back to FIG. 6, memory 602 may store executable instructions, including VMS server device logic code 606, VMS client logic code 608, and VMS GUI logic code 610. VMS server device logic code 606 may be executed by the processor 202 associated with VMS server device 102. Likewise, VMS client logic code 608 may be executed by the processor 206 associated with VMS client device 106, and VMS GUI logic code 610 may be executed by processor 208 associated with VMS GUI device 108.

As indicated, VMS server device 102 is operatively coupled to memory 602 via expansion bus 604 such that VMS server device 102 may obtain VMS server device logic code 606 from memory 602 for execution. Similarly, VMS client device 106 is operatively coupled to memory 602 via expansion bus 604 such that VMS client device 106 may obtain VMS client logic code 608 from memory 602 for execution, and VMS GUI device 108 is operatively coupled to memory 602 via expansion bus 604 such that VMS GUI device 108 may obtain VMS GUI logic code 610 from memory 602 for execution. In one example, VMS GUI device 108 executes VMS GUI logic code 610 in a Linux operating system environment. Memory 602 may be any suitable memory, such as random access memory (RAM), non-volatile memory (e.g., read-only memory (ROM), flash memory, EPROM, EEPROM, etc.), a disk storage device, or any other suitable memory that may store executable instructions.

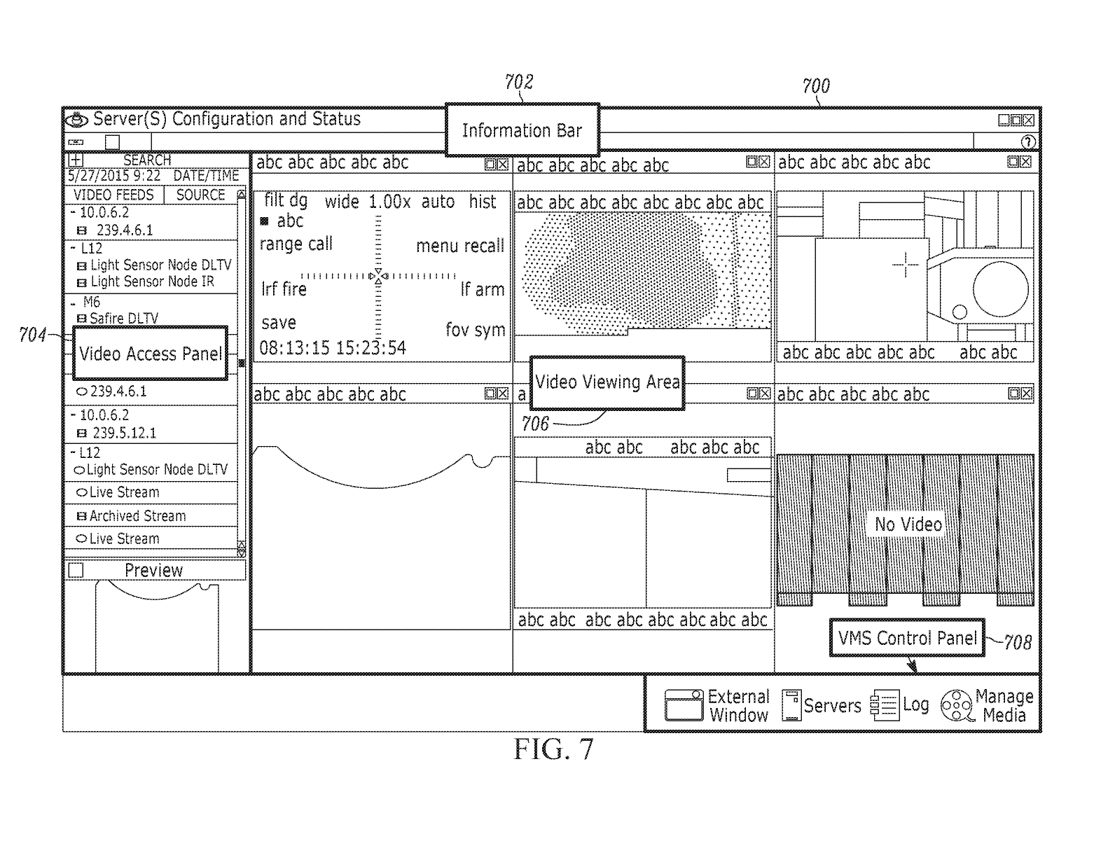

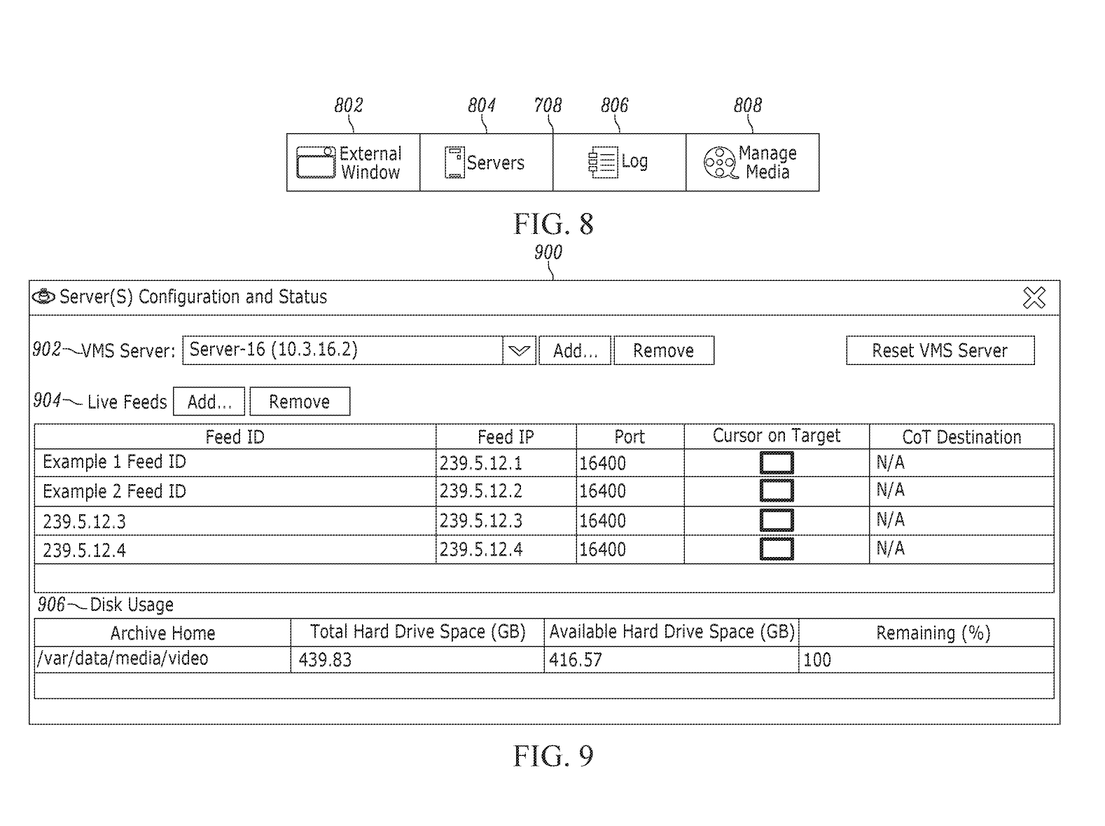

FIG. 7 illustrates a main display window 700 of a GUI that may be displayed by, for example, display 134, and that a user may interact with to initiate one or more functions of the video management system described herein. The main display window 700 is divided into four main areas including the information bar 702, the video access panel 704, the video viewing area 706, and the VMS control panel 708. The information bar 702 allows an operator to view system information, a software user manual, and the system classification. The information bar 702 may also allow an operator to hide, and unhide, the video access panel 704. The video viewing area 706 allows an operator to search for and select videos to view. The VMS control panel 708 allows an operator to configure, monitor, and manipulate VMS server devices 102, video feeds, and general system functions, as described further below with respect to FIG. 8.

The video access panel 704 of the main display window 700 presents to an operator available live and archived video streams, and also allows an operator to search for and select videos to view. For example, the video access panel 704 includes a video search area that allows an operator to search for a video using a “Search” button. The video access panel 704 also includes a video feeds area that shows a listing of available live and archived video feeds. Finally, the video access panel 704 includes a video preview area where a selected video feed may be previewed. The videos may be provided by one or more VMS server devices 102. As shown, the VMS server devices may be identified by a corresponding Internet Protocol (IP) address.

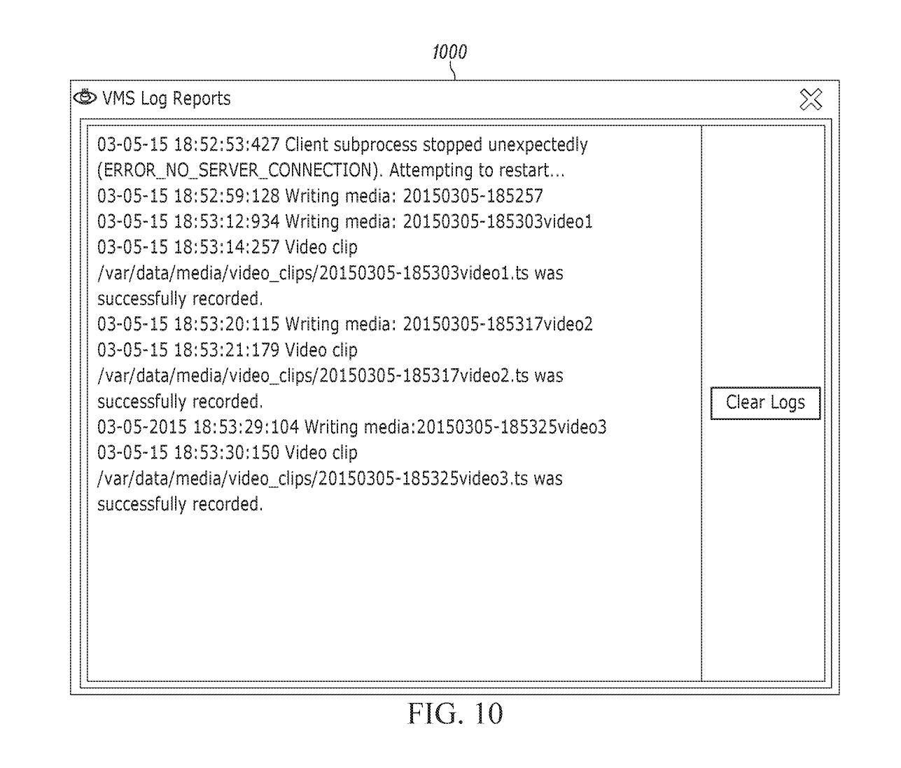

FIG. 8 illustrates the VMS control panel 708 of FIG. 7. The VMS control panel includes four buttons an operator may interact with. The external window button 802 opens a separate video viewing window outside the main display window 700. The servers button 804 allows an operator to configure servers, such as VMS server devices 102, and video feeds, as described further below with respect to FIG. 9. The log button 806 opens up a VMS log report window described further below with respect to FIG. 10. The log button 806 may be displayed in one color when a new log report is received (e.g., red), and in another color when all log reports have been acknowledged (e.g., white). The manage media button 808 allows an operator to view, manage, and export snapshots and video clips that may be saved on the local system, such as a VMS GUI device 108.

FIG. 9 illustrates a server configuration and status window 900 that may be opened by engaging the servers button of FIG. 8. The server configuration and status window 900 includes several functional areas including VMS server functional area 902, live feeds functional area 904, and disk usage functional area 906. VMS server functional area 902 lists all available VMS server devices 102 in a drop-down format with the selected server at the top of the list. Although not shown, connected VMS server devices 102 may be shown in one color (e.g., green), and disconnected servers may be shown in a different color (e.g., red). In addition, VMS server devices 102 may be added or removed using the “Add” and “Remove” buttons, respectively. The live feeds functional area 904 lists all live video feeds associated with a selected VMS server device. Each live feed may be displayed with an associated feed ID, IP address, port number, and CoT details. Live feeds for VMS server devices that are disconnected may not be listed. In addition, video feeds may be added or removed using the “Add” and “Remove” buttons, respectively. The disk usage functional area 906 lists all hard drives available for videos, and snapshots of videos. The disk usage functional area 906 may also list total hard drive space, available hard drive space, and percentage of hard drive space remaining.

FIG. 10 illustrates a VMS log report window 1000 that may be opened by engaging the log button 806 of FIG. 8. The VMS log report window 1000 may display various types of statuses. The VMS log report window 1000 may display the log reports in varying colors depending on the type of log report status for a particular log report. For example, the VMS log report window 1000 may display system errors in one color (e.g., orange). Similarly, the VMS log report window 1000 may display successful operations in another color (e.g., green), and display general system messages in yet another color (e.g., white).

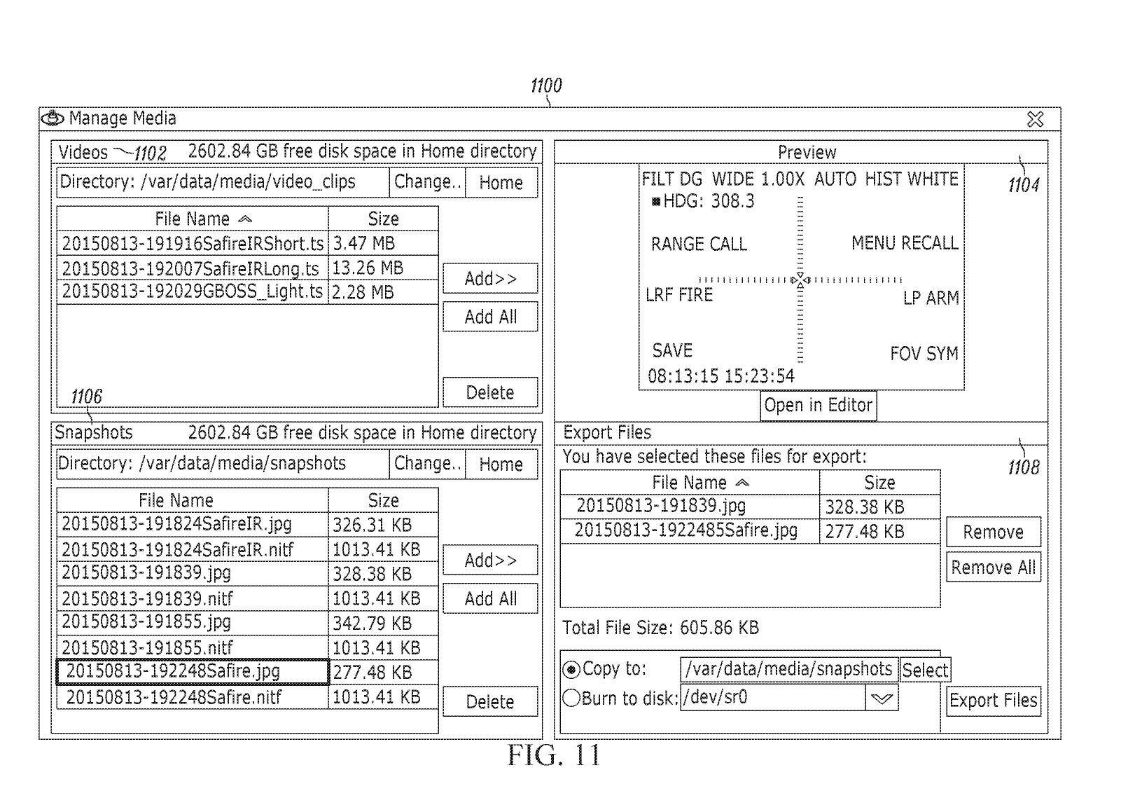

FIG. 11 illustrates a manage media window 1100 that may be opened by engaging the manage media button 808 of FIG. 8. The manage media window 1100 displays video snapshots and recorded video clips saved on the local system. Moreover, the manage media window 1100 allows an operator to import or export the video snapshots and recorded video clips to external media. The manage media window 1100 is divided up into five main functional areas including the videos functional area 1102, the preview functional area 1104, the snapshots functional area 1106, and the export files functional area 1108. The videos functional area 1102 may list video clips saved to the local system in an order in which they were saved. In addition, videos listed may be added to an export list, using the “Add” or “Add All” buttons, to be copied to a removable media device, as described further below. The preview functional area 1104 allows an operator to preview any video or video snapshot. The preview functional area 1104 also allows an operator to edit a video or video snapshot using the “Open in editor” button. The snapshots functional area 1106 lists all video snapshots on the local system in the order in which they were saved. In addition, video snapshots listed may be added to an export list, using the “Add” or “Add All” buttons, to be copied to a removable media device, as described further below. The export files functional area 1108 list all files that have been selected for export to a removable media device. An operator may export the files to the removable media device by engaging the “Export Files” button.

In the foregoing specification, specific embodiments of the present disclosure have been described. However, one of ordinary skill in the art will appreciate that various modifications and changes can be made without departing from the scope of the disclosure as set forth in the claims below. Accordingly, the specification and figures are to be regarded in an illustrative, rather than a restrictive, sense, and all such modifications are intended to be included within the scope of disclosure. The benefits, advantages, solutions to problems, and any element(s) that may cause any benefit, advantage, or solution to occur or become more pronounced are not to be construed as critical, required, or essential features or elements of any or all the claims. The disclosure is defined solely by the appended claims including any amendments made during the pendency of this application and all equivalents of those claims as issued. Although the invention has been described in detail with reference to certain preferred embodiments, variations and modifications exist within the spirit and scope of the invention as described and defined in the following claims.

1. A video management system (VMS) comprising:
a first and one or more second VMS system sections;
wherein said first VMS section comprises a VMS server device comprising:
video stream processing logic adapted to receive multiple video streams and store the multiple video streams in a memory, wherein each video stream of the multiple video streams comprises video data and metadata;
metadata decoder logic adapted to obtain, from the video stream processing logic, at least one video stream of the multiple video streams, read the metadata associated with the at least one video stream, and store the metadata associated with the at least one video stream in a metadata database; and
VMS client control logic adapted to receive a VMS client query command relating to the at least one video stream, wherein the VMS client control logic is further adapted to provide at least one of:
at least one video frame of the at least one video stream based on the received VMS client query command; and
metadata of the at least one video stream based on the received VMS client query command;
wherein said second VMS section device comprises a workstation comprising a VMS graphical user interface (GUI) device and a VMS client device;
wherein said VMS GUI device is adapted to provide for display at least one video frame of a video stream and comprising:
video stream query command logic adapted to provide one or more VMS GUI query commands relating to the at least one video stream of the multiple video streams;
video stream control command logic adapted to provide one or more VMS GUI control commands relating to the at least one video stream of the multiple video streams; and
VMS GUI display logic adapted to provide for display a GUI that allows for control of the displayed at least one video frame of the video stream; and
wherein said VMS client device is operably coupled to the VMS server device and to the VMS GUI device comprising:
VMS GUI command processing logic adapted to:
receive at least one of the one or more VMS GUI query commands and the one or more VMS GUI control commands relating to the at least one video stream of the multiple video streams from the VMS GUI device and determine at least one VMS client query command to transmit to the VMS server device based on the received at least one of the one or more VMS GUI query commands and the one or more VMS GUI control commands; and
provide the at least one VMS client query command to the VMS server device; and
VMS video stream provider logic adapted to receive from the VMS server device the at least one of:
the at least one video frame of the at least one video stream based on the received at least one of the one or more VMS GUI query commands and the one or more VMS GUI control commands; and
the metadata of the at least one video stream based on the received at least one of the one or more VMS GUI query commands and the one or more VMS GUI control commands;
wherein the video stream control command logic of the VMS GUI device is adapted to provide one or more VMS GUI control commands to the VMS client device to command the VMS client device to connect to a second VMS server device to allow the VMS client device to access archived or live video streams on the second VMS server device.

2. The video management system of claim 1 wherein the VMS GUI device, based on a selection of one of a listing of available video streams, provides for display either a live video stream or an archived video stream, wherein:
the video stream control command logic of the VMS GUI device provides at least one of the one or more VMS GUI control commands to the VMS client device based on the selected one of the listing of available video streams; and
the VMS GUI command processing logic of the VMS client device provides a VMS client query command to the VMS server device based on the at least one of the one or more VMS GUI control commands to provide the selected one of the listing of available video streams.

3. The video management system of claim 1 wherein the VMS GUI display logic of the VMS GUI device is further adapted to provide for display metadata associated with the at least one video frame of the video stream.

4. (canceled)

5. The video management system of claim 1 wherein the video stream control command logic of the VMS GUI device is adapted to provide one or more VMS GUI control commands to the VMS client device to control playback of the at least one video stream from the VMS server device.

6. The video management system of claim 1 wherein the video stream control command logic of the VMS GUI device is adapted to provide one or more VMS GUI control commands to the VMS client device to delete the at least one video stream from the VMS server device.

7. The video management system of claim 1 wherein the video stream control command logic of the VMS GUI device is adapted to provide one or more VMS GUI control commands to the VMS client device to add additional video streams to the VMS server device.

8. The video management system of claim 1 wherein the VMS client device comprises at least one video filter, and wherein the video stream control command logic of the VMS GUI device is adapted to provide one or more VMS GUI control commands to the VMS client device to control the application of the at least one video filter to the at least one video stream from the VMS server device.

9. The video management system of claim 1 wherein the video stream query command logic of the VMS GUI device is adapted to provide one or more VMS GUI query commands to the VMS client device to query the VMS server device, based on indicated metadata criteria, for a list of video streams of the stored multiple video streams that satisfy the indicated metadata criteria, wherein:
the video stream query command logic of the VMS GUI device provides at least one of the one or more VMS GUI query commands to the VMS client device; and
the VMS GUI command processing logic of the VMS client device provides the at least one VMS client query command to the VMS server device.

10. The video management system of claim 1 wherein the video stream query command logic of the VMS GUI device is adapted to provide one or more VMS GUI query commands to the VMS client device to query the VMS server device for availability of at least one video stream during a particular timeline of the stored multiple video streams, wherein:
the video stream query command logic of the VMS GUI device provides at least one of the one or more VMS GUI query commands; and
the VMS GUI command processing logic of the VMS client device provides the at least one VMS client query command to the VMS server device.

11. The video management system of claim 1 wherein the video stream query command logic of the VMS GUI device is adapted to provide one or more VMS GUI query commands to the VMS client device to query the VMS server device for a list of available video streams of the stored multiple video streams, wherein:
the video stream query command logic of the VMS GUI device provides at least one of the one or more VMS GUI query commands; and
the VMS GUI command processing logic of the VMS client device provides the at least one VMS client query command to the VMS server device.

12. The video management system of claim 1 wherein the video stream control command logic of the VMS GUI device is adapted to provide one or more VMS GUI control commands to the VMS client device to command the VMS server device to save an image of a video frame of at least one video stream of the stored multiple video streams, wherein:
the video stream control command logic of the VMS GUI device provides at least one of the one or more VMS GUI control commands; and
the VMS GUI command processing logic of the VMS client device provides the at least one VMS client query command to the VMS server device.

13. The video management system of claim 1 wherein the VMS GUI command processing logic of the VMS client device is adapted to provide a response to the VMS GUI device based on receiving the at least one of the one or more VMS GUI query commands and the one or more VMS GUI control commands relating to the at least one video stream of the multiple video streams from the VMS GUI device.

14. A method in a video management system (VMS) comprising:
providing a first and second VMS section, wherein said first VMS section comprises at least one VMS server device and said second VMS section comprises a workstation including a VMS graphical user interface (GUI) device and a VMS client device;
receiving, at the VMS server device, multiple video streams and storing the multiple video streams in a memory, wherein each video stream of the multiple video streams comprises video data and metadata;
reading, by the VMS server device, the metadata associated with the at least one video stream, and storing the metadata associated with the at least one video stream in a metadata database;
receiving, by the VMS server device, a VMS client query command relating to the at least one video stream, and providing at least one of:
at least one video frame of the at least one video stream based on the received VMS client query command; and
metadata of the at least one video stream based on the received VMS client query command;
providing, by the VMS GUI device adapted to provide for display at least one video frame of a video stream, one or more VMS GUI query commands relating to the at least one video stream of the multiple video streams;
providing, by the VMS GUI device, one or more VMS GUI control commands relating to the at least one video stream of the multiple video streams;
providing for display, by the VMS GUI device, a GUI that allows for control of the displayed at least one video frame of the video stream;
receiving, at the VMS client device, at least one of the one or more VMS GUI query commands and the one or more VMS GUI control commands relating to the at least one video stream of the multiple video streams from the VMS GUI device and determining at least one VMS client query command to transmit to the VMS server device based on the received at least one of the one or more VMS GUI query commands and the one or more VMS GUI control commands;
providing, by the VMS client device, the at least one VMS client query command to the VMS server device;
receiving, at the VMS client device, from the VMS server device the at least one of:
the at least one video frame of the at least one video stream based on the received at least one of the one or more VMS GUI query commands and the one or more VMS GUI control commands; and
the metadata of the at least one video stream based on the received at least one of the one or more VMS GUI query commands and the one or more VMS GUI control commands;
providing, by the VMS GUI device, one or more VMS GUI control commands to the VMS client device to command the VMS client device to connect to a second VMS server device to allow the VMS client device to access archived or live video streams on the second VMS server device.

15. The method of claim 14 wherein:
based on a selection of one of a listing of available video streams, providing for display either a live video stream or an archived video stream;
providing at least one of the one or more VMS GUI control commands to the VMS client device based on the selected one of the listing of available video streams; and
providing at least one VMS client query command, based on the at least one or more VMS GUI control commands, to the VMS server device to provide the selected one of the listing of available video streams.

16. The method of claim 14 further comprising providing for display metadata associated with the at least one video frame of the video stream.

17. (canceled)

18. The method of claim 14 further comprising providing, by the VMS GUI device, one or more VMS GUI control commands to the VMS client device to control playback of the at least one video stream from the VMS server device.

19. The method of claim 14 further comprising providing, by the VMS GUI device, one or more VMS GUI control commands to the VMS client device to delete the at least one video stream from the VMS server device.

20. The method of claim 14 further comprising providing, by the VMS GUI device, one or more VMS GUI control commands to the VMS client device to add additional video streams to the VMS server device.

21. The method of claim 14 further comprising providing, by the VMS GUI device, one or more VMS GUI control commands to the VMS client device to control the application of at least one video filter to the at least one video stream from the VMS server device.

22. The method of claim 14 further comprising providing, by the VMS GUI device, one or more VMS GUI query commands to the VMS client device to query the VMS server device, based on indicated metadata criteria, for a list of video streams of the stored multiple video streams that satisfy the indicated metadata criteria, wherein:
the VMS GUI device provides at least one of the one or more VMS GUI query commands to the VMS client device; and
the VMS client device provides, based on the one or more VMS GUI query commands, the at least one VMS client query command to the VMS server device.

23. The method of claim 14 further comprising providing, by the VMS GUI device, one or more VMS GUI query commands to the VMS client device to query the VMS server device for availability of at least one video stream during a particular timeline of the stored multiple video streams, wherein:
the VMS GUI device provides at least one of the one or more VMS GUI query commands to the VMS client device; and
the VMS client device provides the at least one VMS client query command to the VMS server device.

24. The method of claim 14 further comprising providing, by the VMS GUI device, one or more VMS GUI query commands to the VMS client device to query the VMS server device for a list of available video streams of the stored multiple video streams, wherein:
the VMS GUI device provides at least one of the one or more VMS GUI query commands; and
the VMS client device provides, based on the at least one of the one or more VMS GUI query commands, the at least one VMS client query command to the VMS server device.

25. The method of claim 14 further comprising providing, by the VMS GUI device, one or more VMS GUI control commands to the VMS client device to command the VMS server device to save an image of a video frame of at least one video stream of the stored multiple video streams, wherein:
the VMS GUI device provides at least one of the one or more VMS GUI control commands to the VMS client device; and
the VMS client device provides, based on the at least one of the one or more VMS GUI control commands, the at least one VMS client query command to the VMS server device.

26. The method of claim 14 further comprising providing, by the VMS client device, a response to the VMS GUI device based on receiving the at least one of the one or more VMS GUI query commands and the one or more VMS GUI control commands relating to the at least one video stream of the multiple video streams from the VMS GUI device.

27. (canceled)
